(19) United States
(12) Patent Application Publication
(10) Pub. No.: US 2023/0101275 A1
(43) Pub. Date: Mar. 30, 2023

(54) AUDITED TRAINING DATA FOR AN ITEM RECOGNITION MACHINE LEARNING MODEL SYSTEM

(71) Applicant: Toshiba Global Commerce Solutions Holdings Corporation, Tokyo (JP)

(72) Inventors: Andrei KHAITAS, McKinney, TX (US); Manuel M. MONSERRATE, Katy, TX (US); Evgeny SHEVTSOV, Frisco, TX (US); Michelle M. CROMPTON, Raleigh, NC (US)

(21) Appl. No.: 17/489,047

(22) Filed: Sep. 29, 2021

(51) Int. Cl. G06Q 20/20; G06Q 30/06; G06N 20/00

(52) U.S. Cl. CPC G06Q 20/202; G06Q 30/0623; G06N 20/00

(57) ABSTRACT

Techniques for training an item recognition machine learning (ML) model are disclosed. An image of a first item for purchase is received. The image is captured by a point of sale (POS) system. A purchaser selection of a second item for purchase is also received. The purchaser makes the selection at the POS system. It is determined that the first item for purchase matches the second item for purchase, and in response training data is generated for an image recognition ML model, based on the image and the determination that the first item for purchase matches the second item for purchase. The ML model is trained using the training data, and the trained ML model is configured to recognize items for purchase in a plurality of images captured by a plurality of POS systems.

### BACKGROUND

Retailers often provide purchasers with the option to undertake self-checkout, as an alternative to assisted checkout (e.g., provided by an employee of the retailer). Purchaser can use POS systems to scan and tally items, and to pay the resulting bill. Some items, however, do not include a code for automatic scanning (e.g., do not include a universal product code (UPC)). For these items, purchasers typically must use the POS system to identify the item. For example, purchasers can identify the item by reviewing pictures of item options or textual labels for item options, or by entering a product code (e.g., entering an alphanumeric product code). This can be inefficient, inaccurate, and detrimental to the retailer, and can cause frustration and delay for purchasers.

### BRIEF DESCRIPTION OF THE SEVERAL VIEWS OF THE DRAWINGS

FIG. 1A illustrates an example checkout area with auditing of training data for an item recognition ML model, according to one embodiment.

FIG. 1B illustrates an example administration system with auditing of training data for an item recognition ML model, according to one embodiment.

FIG. 2 illustrates a checkout controller for auditing of training data for an item recognition ML model, according to one embodiment.

FIG. 3 is a flowchart illustrating adding a new item with auditing of training data for an item recognition ML model, according to one embodiment.

FIG. 4 is a flowchart illustrating collecting and auditing training data for an item recognition ML model, according to one embodiment.

FIG. 5A is a flowchart illustrating auditing training data for an item recognition ML model, according to one embodiment.

FIG. 5B illustrates a user interface for auditing training data for an item recognition ML model, according to one embodiment.

FIG. 6 is a flowchart illustrating training an item recognition ML model, according to one embodiment.

FIG. 7 is a flowchart illustrating updating and auditing training data for an item recognition ML model, according to one embodiment.

FIG. 8 is a flowchart illustrating use of an item recognition ML model for self-checkout, according to one embodiment.

### DETAILED DESCRIPTION

As discussed above, some retail items, for example produce, do not include a UPC or another code for automatic scanning at a POS system. In prior solutions, a customer is typically required to manually identify the item at the POS system, for example by searching for the item using images or textual labels, or by entering an alphanumeric product code. In an embodiment, a POS system can, instead, predict an item that a customer is purchasing, and can prompt the customer to confirm the predicted item.

For example, a POS system can include one or more image capture devices (e.g., cameras) to capture one or more images of the item. The POS system can then use image recognition techniques (e.g., machine learning (ML) techniques) to predict the item depicted in the images. The POS system can then present the customer with the predicted item, and allow the purchaser to confirm the prediction or select a different item (e.g., if the prediction is incorrect).

In an embodiment, image recognition can be performed using a trained ML model (e.g., a suitable neural network). This ML model can be trained using real-word data reflecting purchaser selection of items, and captured images of these items. These selections can be used as ground truth to train the ML model.

This real-world data, however, may not always be accurate. In an embodiment, purchasers do not accurately select the item that they are seeking to purchase. For example, purchasers may mistakenly select one item when they are actually purchasing a different item. This could occur when a purchaser mistakenly provides the wrong input to a user interface (e.g., mistakenly touches a picture of the wrong item on a touch sensitive screen) or when the purchaser themselves does not realize what item they are actually purchasing. As another example, purchasers may intentionally select the incorrect item. For example, purchasers may intentionally select a cheaper item compared to the item they are actually purchasing (e.g., purchasers may select a non-organic produce item when they are actually purchasing an organic produce item).

Using this inaccurate real-world purchase data as the ground truth for training an ML model can result in inaccuracies in the model. This can be improved by auditing the real-world purchase data before the data is used to train the ML model. In an embodiment, the real-world purchase data can be provided to an auditing system for verification before the data is used to train the ML model.

For example, the real-world purchase data can be provided to a human auditor, who can review the purchaser selection and either confirm its accuracy or not the selection's inaccuracy. Alternatively, or in addition, the real-world purchase data can be provided to an additional ML model trained to audit the data. The audited data can then be used to train the ML model, increasing the accuracy of inference by the ML model.

### Advantages to Point of Sale Systems

Advantageously, one or more of these techniques can improve prediction of items for purchase at a POS system using image recognition. For example, this can improve the performance of the POS system by enabling it to detect, using an image recognition system, an item being purchased without having to rely on the purchaser to scan a UPC or manually type in a name of the item. The embodiments herein also advantageously provide for improved training data for the ML model. This can improve the performance of the ML model, improving the accuracy of the prediction of items for purchase. In addition to the advantages described above, these techniques have many additional technical advantages. For example, improving the accuracy of prediction reduces the computational burden on the system, by lessening the number of transactions required, because accurate item prediction reduces the number of searches initiated by a user. As another example, improving the training data for the ML model can provide advantages for the ML model. More accurate training data can allow for a less heavily trained ML Model (e.g., requiring less training data to meet a required accuracy threshold), and can require less computationally intensive training.

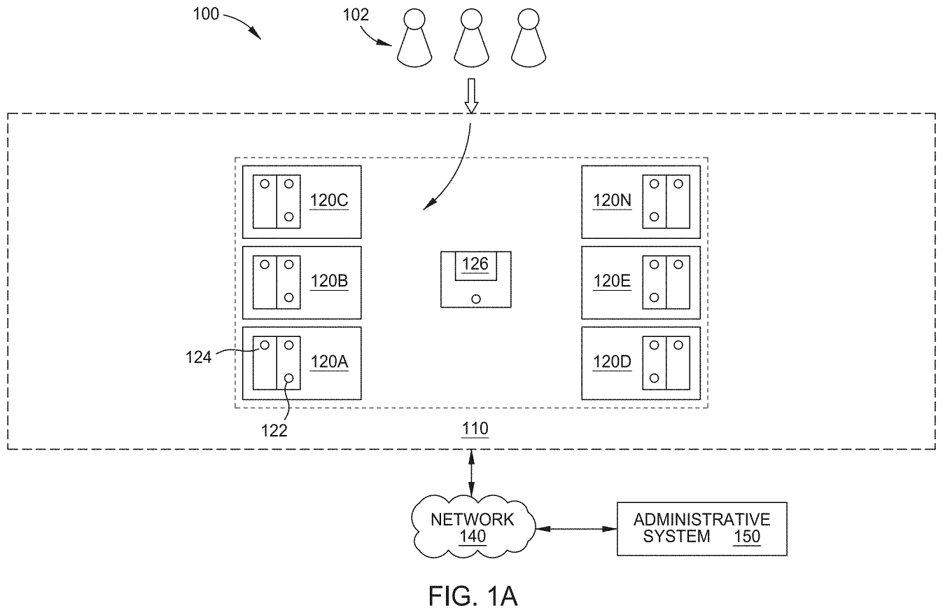

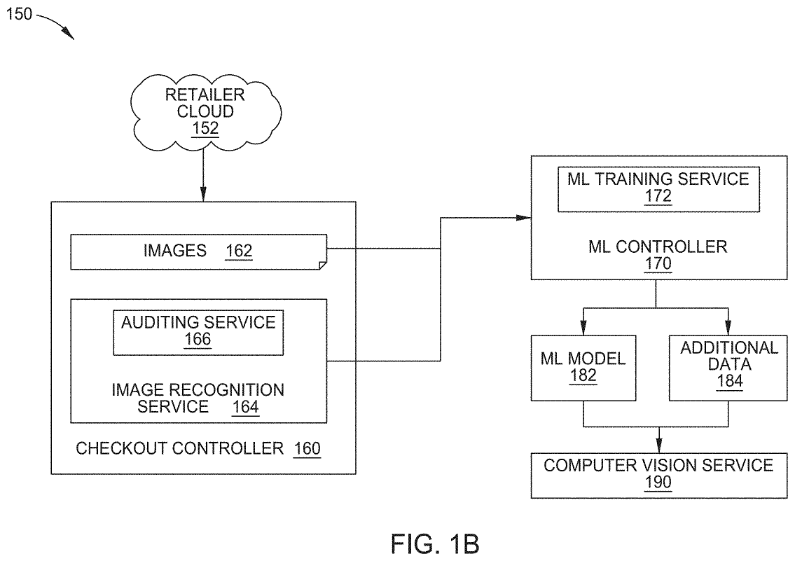

FIG. 1A illustrates an example checkout area with auditing of training data for an item recognition ML model, according to one embodiment. In an embodiment, the checkout area 100 relates to a retail store environment (e.g., a grocery store). This is merely one example, and the checkout area 100 can relate to any suitable environment.

One or more purchasers 102 use a checkout area 110 (e.g., to pay for purchases). In an embodiment, the checkout area 110 includes multiple point of sale (POS) systems 120A-N. For example, one of the purchasers 102 can use one of the POS systems 120A-N for self-checkout to purchase items. The checkout area 110 further includes an employee station 126. For example, an employee (e.g., a retail employee) can use the employee station 126 to monitor the purchasers 102 and the POS systems 120A-N. Self-checkout is merely one example, and the POS systems 120A-N can be any suitable systems. For example, the POS system 120A can be an assisted checkout kiosk in which an employee assists a purchaser with checkout.

In an embodiment, each of the POS systems 120A-N includes components used by the purchaser for self-checkout. For example, the POS system 120A includes a scanner 122 and an image capture device 124. In an embodiment, one of the purchasers 102 can use the scanner to identify items for checkout. For example, the purchaser 102 can use the scanner 122 to scan a UPC on an item.

In an embodiment, the scanner 122 is a component of the POS system 120A and identifies an item for purchase based on the scanner activity. For example, the POS system 120A can communicate with an administration system 150 using a network 140. The network 140 can be any suitable communication network, including a local area network (LAN), wide area network (WAN), cellular communication network, the Internet, or any other suitable communication network. The POS system 122A can communicate with the network 140 using any suitable network connection, including a wired connection (e.g., an Ethernet connection), a WiFi connection (e.g., an 802.11 connection), or a cellular connection.

In an embodiment, the POS system 120A can communicate with the administration system 150 to identify items scanned by a purchaser 102, and to perform other functions relating to self-checkout. The administration system 150 is illustrated further with regard to FIG. 1B. For example, the POS system 120A can use the administration system 150 to identify an item scanned using the scanner 122 (e.g., by scanning a UPC). FIG. 1 illustrates the administration system 150 connected to the checkout area 110 using the communication network 140. The administration system 150 can reply to the POS system 120A with the identifying information for the item (e.g., alphanumeric UPC, PLU code, SKU code, price, textual description, or any other suitable information). This is merely an example, and the administration system 150 can be fully, or partially, maintained at a local computer accessible to the POS system 120A without using a network connection (e.g., maintained on the POS system 120A itself or in a local storage repository).

Further, in an embodiment, the image capture device 124 (e.g., a camera) is also a component of the POS system 120A and can be used to identify the item that a purchaser is seeking to purchase. For example, the image capture device 124 can capture one or more images of an item a purchaser 102 is seeking to purchase. The POS system 120A can transmit the images to the administration system 150 to identify the item depicted in the images. The administration system 150 can then use a suitable trained ML model to identify the items depicted in the image, and can reply to the POS system 120A with identification information for the identified item.

For example, the administration system 150 can transmit to the POS system 120A a code identifying the item (e.g., a PLU). The POS system 120A can use the code to lookup the item and present the item to the user (e.g., displaying an image relating to the item and a textual description relating to the item). In an embodiment, information about the item presented to the user (e.g., a stock image and textual description) is maintained at the POS system 120A. Alternatively, this information can be maintained at another suitable location. For example, the POS system 120A can communicate with any suitable storage location (e.g., a local storage location or a cloud storage location) to retrieve the information (e.g., using the identifying code for the item). Alternatively, or in addition, the administration system 150 can provide the information (e.g., the image and textual description) to the user.

FIG. 1B illustrates an example administration system 150 with auditing of training data for an item recognition ML model, according to one embodiment. In an embodiment, a retailer cloud 152 maintains item information. For example, the retailer cloud 152 can maintain images 162 associated with items available for purchase from the retailer. The retailer cloud 152 can provide these images 162 to a checkout controller 160, which can maintain the image in a suitable storage location. In embodiment, the retailer cloud 152 can be any suitable storage location, including a public cloud, a private cloud, a hybrid cloud, or a local storage location. Similarly, the storage location for the images 162 at the checkout controller 160 can be any suitable storage location, including a public cloud, a private cloud, a hybrid cloud, or a local storage location.

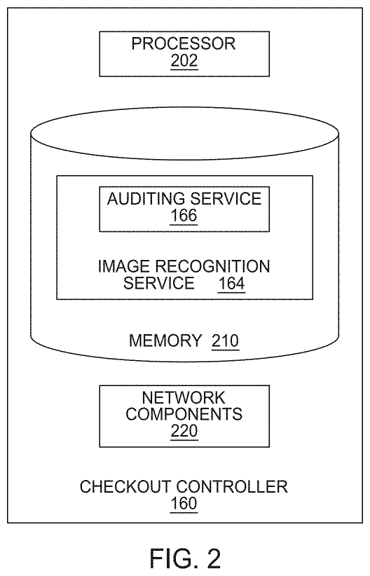

In an embodiment, the checkout controller includes an image recognition service 164, which includes an auditing service 166. This is discussed further below with regard to FIG. 2. In an embodiment, the image recognition service 164 facilitates item recognition and the auditing service 166 facilitates auditing purchaser data to generate training data for an item recognition ML model.

In an embodiment, the checkout controller 160 provides the images 162, and the results of the image recognition service 164, to an ML controller 170. The ML controller 170 includes an ML training service 172. In an embodiment, the ML training service 172 is computer program code, stored in a memory, and configured to train an ML model when executed by a computer processor. For example, the ML training service 172 can train an ML model 182 using the images 162 and the results of the image recognition service 164. The ML model 182 can be any suitable supervised ML model for image recognition, including a deep learning neural network. For example, a suitable convolutional neural network (CNN) can be used. This is merely one example, and any suitable supervised ML model can be used.

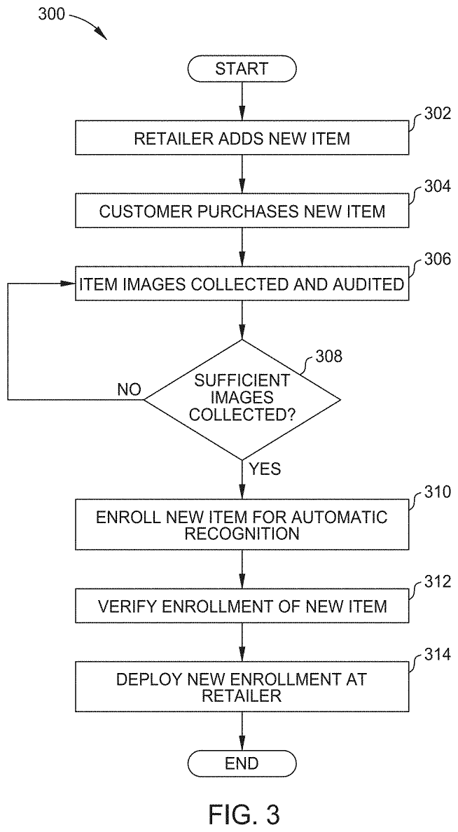

The ML controller 170 can then provide the ML model 182, and any suitable additional data 184, to a computer vision service 190. In an embodiment, the ML model 182 is a suitable supervised ML model for image recognition (e.g., trained using the ML training service 172). The computer vision service 190 can use the ML model 182 (along with any suitable additional data 184) to recognize items for purchase in images captured during checkout. This is discussed further with regard to FIGS. 3-8, below.

FIG. 2 illustrates a checkout controller 160 for auditing of training data for an item recognition ML model, according to one embodiment. The checkout controller 160 includes a processor 202, a memory 210, and network components 220. The processor 202 generally retrieves and executes programming instructions stored in the memory 210. The processor 202 is representative of a single central processing unit (CPU), multiple CPUs, a single CPU having multiple processing cores, graphics processing units (GPUs) having multiple execution paths, and the like.

The network components 220 include the components necessary for the checkout controller 160 to interface with a suitable communication network (e.g., the communication network 140 illustrated in FIG. 1A). For example, the network components 220 can include wired, WiFi, or cellular network interface components and associated software. Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory.

The memory 210 generally includes program code for performing various functions related to use of the checkout controller 160. The program code is generally described as various functional “applications” or “modules” within the memory 210, although alternate implementations may have different functions and/or combinations of functions. Within the memory 210, the image recognition service 164 facilitates item recognition and the auditing service 166 facilitates auditing purchaser data to generate training data for an item recognition ML model. This is discussed further below with regard to FIGS. 3-8.

FIG. 3 is a flowchart 300 illustrating adding a new item with auditing of training data for an item recognition ML model, according to one embodiment. At block 302 a retailer adds a new item for sale. For example, a grocery store can add a new item of produce. In an embodiment, the retailer adds a code for this item (e.g., a PLU) as a valid code and makes the item valid for purchase in the retailer's stores.

At block 304, a purchaser purchases the new item. In an embodiment, the customer can use a POS system (e.g., the POS system 120A illustrated in FIG. 1A). In an embodiment, the POS system attempts to predict the item for purchase using image recognition. Because the item is new, however, it is not yet available for image recognition. In an embodiment, the purchaser instead enters a code (e.g., a PLU) for the item.

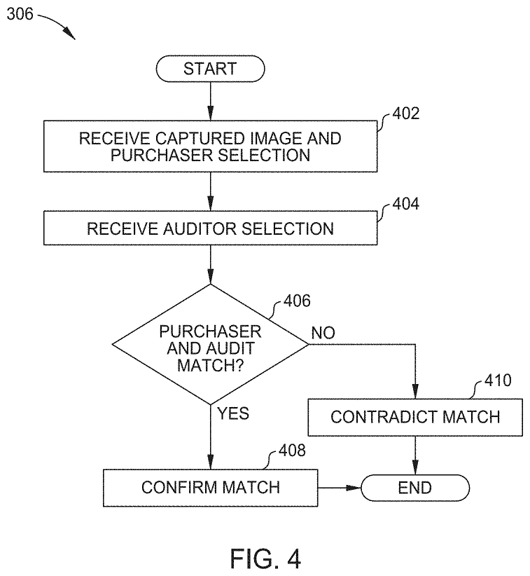

At block 306 an image recognition service (e.g., the image recognition service 164 illustrated in FIGS. 1B and 2) facilitates collecting and auditing item images (e.g., for future image recognition). This is discussed further with regard to FIGS. 4-6). For example, an auditing service (e.g., the auditing service 166 illustrated in FIGS. 1B and 2) can receive an image of the new item (e.g., from the retailer's cloud 152 illustrated in FIG. 1B) and a captured image of the transaction (e.g., from the POS system). The auditing service can determine whether the user's selection of the item is accurate, based on the image of the new item and the image of the transaction. If the selection is accurate, it is marked as correct and an image of the item and of the transaction are used to train an ML model for image recognition (e.g., as illustrated in FIG. 1B). In an embodiment, if the selection is inaccurate, it is marked as incorrect and the image of the item and of the transaction are also used to train the ML model (e.g., the inaccuracy is used to train the ML model).

At block 308, the image recognition service determines whether sufficient images have been collected to train the ML model for image recognition. For example, the image recognition can communicate with an ML training service (e.g., the ML training service 172 illustrated in FIG. 1B) to determine whether the model has sufficient training data. This can be determined based on estimated metrics, based on empirical performance of the model, or in any other suitable fashion. If not, the flow returns to block 306 and additional images are collected and audited.

If sufficient images have been collected, the flow proceeds to block 310. At block 310 the image recognition service enrolls the new item for image recognition. In an embodiment, the item is enrolled in the ML model and added as a permissible product code (e.g., PLL) for the POS system.

At block 312, the image recognition service verifies the enrollment of the new item. For example, the image recognition service can test the accuracy of the ML model for the new item by determining whether the ML model can correctly identify a set number of pre-selected items (e.g., 20 items). This is merely one example, and any suitable verification technique can be used. Assuming the image recognition service verifies the enrollment of the new item, the flow proceeds to block 314.

At block 314, the image recognition service deploys the new item at the retailer. For example, the image recognition can deploy the verified ML model for the POS systems. In an embodiment, the POS systems access the ML model through a suitable network connection, as illustrated in FIG. 1A. Alternatively, the ML model can be deployed locally on the POS systems or can be deployed on a suitable central storage location co-located with the POS systems.

FIG. 4 is a flowchart illustrating collecting and auditing training data for an item recognition ML model, according to one embodiment. In an embodiment, FIG. 4 corresponds with block 306 in FIG. 3. At block 402 an auditing service (e.g., the auditing service 166 illustrated in FIGS. 1B and 2) receives a captured image and a purchaser selection.

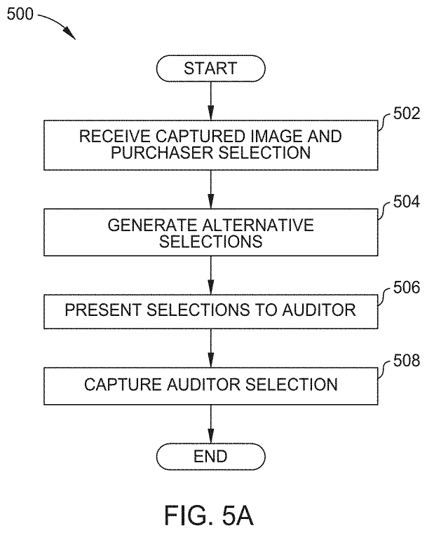

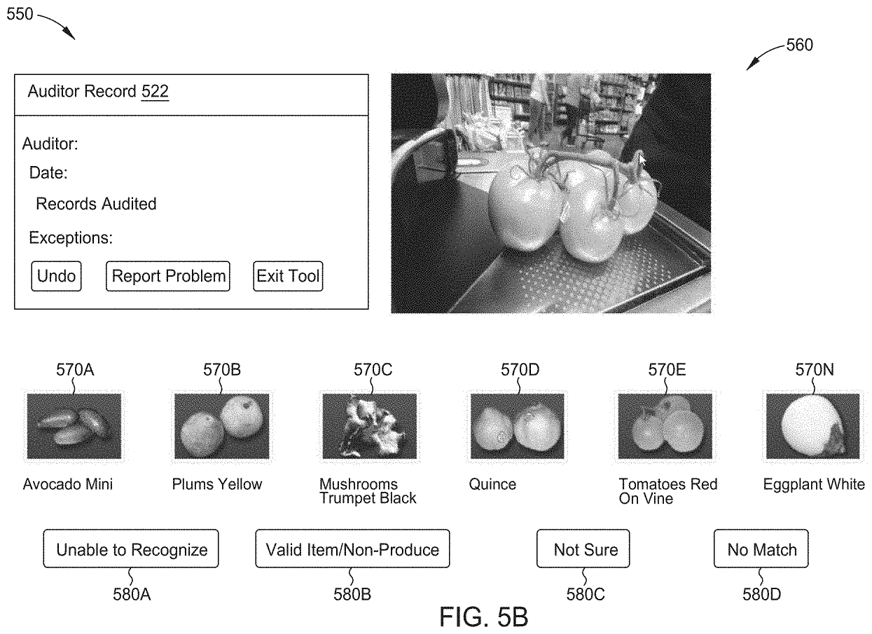

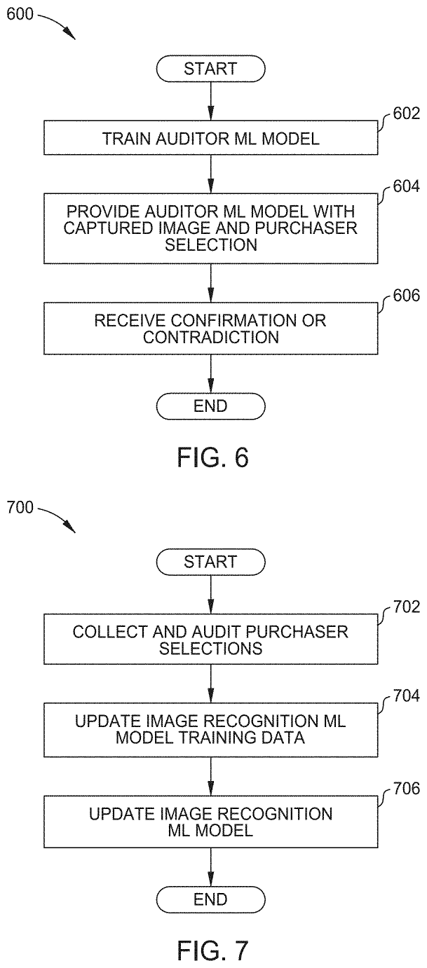

At block 404, the auditing service receives an auditor selection. This is discussed further with regard to FIGS. 5A-B and 6. For example, a human auditor can be presented with the captured image and the purchaser selection, and can confirm or contradict the purchaser selection (e.g., as illustrated in FIGS. 5A-B). As another example, an additional ML model can be trained to act as an auditor, and can confirm or contradict the purchaser selection (e.g., as illustrated in FIG. 6).

At block 406, the auditing service determines whether the purchaser selection and the auditor selection match. If so, the flow proceeds to block 408 and the match is confirmed. For example, the auditing service can provide the customer match as training data for the image recognition ML model and can note that the match is confirmed (e.g., by including an annotation that the selection is confirmed).

If not, the flow proceeds to block 410 and the match is contradicted. For example, the auditing service can provide the captured image and customer match as training data for the image recognition ML model and can note that the match is contradicted (e.g., by including an annotation that the selection is contradicted). In an embodiment, both confirmed and contradicted data is useful for training the ML model. Alternatively, only confirmed matches can be used to train the ML model.

FIG. 5A is a flowchart 500 illustrating auditing training data for an item recognition ML model, according to one embodiment. At block 502 an auditing service (e.g., the auditing service 166 illustrated in FIGS. 1B and 2) receives a captured image (e.g., a captured image of a retail transaction at a POS system) and a purchaser selection.

At block 504, the auditing service generates alternative selections (e.g., for a human auditor). In an embodiment, as illustrated in FIG. 5B, the auditing service can present a user interface in which a human auditor can view the captured image, and a number of choices of the item captured. These choices can include the purchaser selection, along with alternative choices. In an embodiment, the alternative choices are randomly selected (e.g., from a database of available items for purchase).

At block 506, the auditing service presents the selections to the auditor. For example, the auditing service can generate a suitable user interface presenting the selections to the auditor. This is illustrated in FIG. 5B.

At block 508, the auditing service captures the auditor selection. In an embodiment, the auditing service determines whether the auditor selection confirms, or contradicts, the purchase selection. The auditing service then provides this information to an ML model as part of the ML model's training data.

FIG. 5B illustrates a user interface 550 for auditing training data for an item recognition ML model, according to one embodiment. In an embodiment, the user interface 550 includes a captured image 560 of the retail transaction (e.g., captured by a POS system). The user interface 550 presents to a human auditor a selection of options for the human auditor to match with the captured image. In an embodiment, the selection of options includes a purchaser selection and a number of alternative options. As discussed above, the alternative options can be randomly selected (e.g., from a selection of available items). The auditor can then select the matching item from the alternatives 570A-N, or can selection from a number of additional inputs 580A-D, including “Unable to Recognize,” “Valid Item/Non-Produce” (e.g., an item that includes a UPC that could have been scanned by the purchaser), “Not Sure,” or “No Match” (e.g., the item depicted in the captured image 560 does not appear in the group of alternatives 570A-N.

For example, in FIG. 5B assume the captured image depicts red tomatoes on the vine, and the purchaser correctly selected red tomatoes on the vine. The auditor is presented with numerous item options, including the purchaser selected option (e.g., 570E) and five randomly generated alternative options (e.g., 570A, 570B, 570C, 570D, and 570N). The auditor can select item 570E, confirming the purchaser selection.

In an embodiment, the user interface 550 further includes an auditor record 552. For example, the auditor record 552 can provide statistics and data relating to the auditor. The auditor record 552 can further allow the auditor to control the user interface.

Further, in an embodiment, auditing using the user interface 550 can be used to assist with loss prevention. For example, as discussed above, a purchaser selection of an item that does not match the prediction could be intentional. Purchasers may intentionally select a cheaper item compared to the item they are actually purchasing (e.g., purchasers may select a non-organic produce item when they are actually purchasing an organic produce item). In an embodiment, an auditor could identify a potentially suspicious transaction using the user interface 550.

For example, the auditor can select the “Report Problem” interface in the auditor record 552 section. This could flag the transaction for further analysis. For example, selecting the “Report Problem” interface could forward a screenshot of the transaction (e.g., the captured image 560 and the purchaser selection) for further analysis. The screenshot could be analyzed, either manually or using a suitable automatic analysis tool (e.g., an ML model), and it could be determined whether the purchaser was likely intentionally selecting the incorrect item. This could be used to modify the POS system (e.g., providing additional loss prevention checks) or to provide additional loss prevention assistance.

FIG. 6 is a flowchart 600 illustrating training an item recognition ML model, according to one embodiment. In an embodiment, at block 602 an auditing service (e.g., the auditing service 166 illustrated in FIGS. 1B and 2) trains an auditor ML model. For example, the auditor ML model can be different from the image recognition ML model used with customers (e.g., the auditor ML model can be trained to output a binary choice confirming or contradicting a user selection, rather than a classification of an image). The auditor ML model can be trained using different data (e.g., using data generated by human auditors) and can be structured differently. For example, the auditor ML model can be a deep learning model with a different structure from the image recognition ML model, or with the same structure as the image recognition ML model but with different training.

At block 604, the auditing service provides the auditor ML model with the captured image and the purchaser selection. In an embodiment, the auditor ML model infers a binary output using the captured image and the purchaser selection, either confirming or contradicting the selection. At block 606, the auditing service receives the inference of confirmation or contradiction.

As illustrated in FIG. 6, the auditor ML model infers a binary output confirming or contradicting the purchaser selection. This is merely one example, and the auditor ML model could provide additional information. For example, the auditor ML model could infer whether the item in the captured image is scannable item with a UPC code, for which image recognition should not have been necessary (e.g., input 580B illustrated in FIG. 5B).

FIG. 7 is a flowchart 700 illustrating updating and auditing training data for an item recognition ML model, according to one embodiment. In an embodiment, as discussed above in relation to FIG. 3, an image recognition ML model is trained when an item is first added by a retailer as an option for purchase. Alternatively, or in addition, the ML model can be continuously updated and trained using ongoing purchaser data.

For example, at block 702, an auditing service (e.g., the auditing service 166 illustrated in FIGS. 1B and 2) collects and audits purchaser selections. For example, the auditing service can continue to collect purchaser selections throughout operation of POS systems at a retail store, and can audit a portion of those selections.

At block 704, the auditing service updates the image recognition ML model training data. For example, the auditing service can confirm, or contradict, purchaser selections of items (e.g., as discussed above in relation to FIGS. 4-6) and can provide that confirmation, or contradiction, as part of the training data for the image recognition ML model.

At block 706, an ML training service (e.g., the ML training service 172 illustrated in FIG. 1B) updates the image recognition ML model. For example, the ML training service can continuously train the ML model using the updated training data (e.g., updated at block 704).

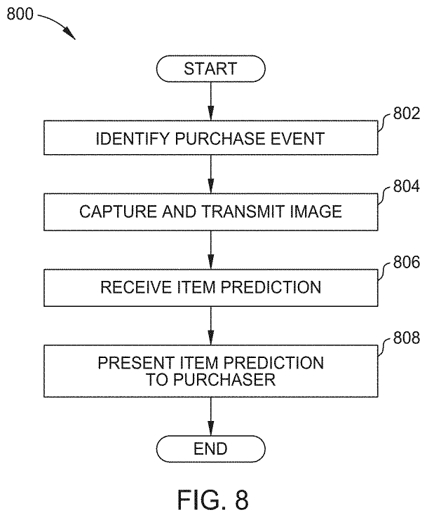

FIG. 8 is a flowchart 800 illustrating use of an item recognition ML model for self-checkout, according to one embodiment. At block 802 a POS system (e.g., the POS system 120A illustrated in FIG. 1A) identifies a purchase event. For example, a purchaser may be attempting to purchase an item that does not include a scannable code (e.g., a UPC code). The purchase event can be triggered through interaction from the purchaser (e.g., selecting an option in a user interface), an environmental sensor (e.g., a weight or motion sensor) or in any other suitable fashion.

At block 804, the POS system captures and transmits an image of the item being purchased. For example, the POS system can include an image capture device (e.g., the image capture device 124 illustrated in FIG. 1A). The image capture device can capture one or more images of the item. Further, the POS system can transmit the captured image(s) of the item to an image recognition service (e.g., the image recognition service 164 illustrated in FIGS. 1 and 2). For example, the POS system can transmit the image(s) to an administration system (e.g., the administration system 150 illustrated in FIG. 1) using a suitable communication network (e.g., the network 140 illustrated in FIG. 1). Alternatively, or in addition, the image recognition service can reside locally at the POS system, or at a location co-located with the POS system.

As discussed above in relation to FIGS. 1-7, the image recognition service can use image recognition to identify the item depicted in the captured image. For example, the image recognition service can use a trained ML model (e.g., the ML model 182 illustrated in FIG. 1B) to recognize the item in the image. In an embodiment, the ML model is trained using audited training data, as discussed above in relation to FIGS. 3-7.

At block 806 the POS system receives the item prediction. In an embodiment, the POS system receives a code relating to the item (e.g., a PLU code) and uses the code to identify a description and image for the item. Alternatively, or in addition, the POS system receives the description and image for the item (e.g., from an administration system).

At block 808, the POS system presents the items to the purchaser. For example, the POS system can use the item code(s) received at block 806 to identify enrolled items for the retailer. Alternatively, or in addition, the POS system can use description and images received at block 806. The POS system can present the predicted item to the user for selection.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the administration system 150 illustrated in FIG. 1) or related data available in the cloud. For example, the administration system 150 could execute on a computing system in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method comprising:
receiving an image of a first item for purchase, wherein the image is captured by a point of sale (POS) system;
receiving a purchaser selection of a second item for purchase, wherein the purchaser makes the selection at the POS system; and
determining that the first item for purchase matches the second item for purchase, and in response:
generating training data for an image recognition machine learning (ML) model based on the image and the determination that the first item for purchase matches the second item for purchase; and
training the ML model using the training data, wherein the trained ML model is configured to recognize items for purchase in a plurality of images captured by a plurality of POS systems.

2. The method of claim 1, wherein determining that the first item for purchase matches the second item for purchase comprises:
presenting the image of the first item for purchase, a second image relating to the second item for purchase, and one or more additional images on a user interface; and
receiving by the user interface an indication that the first item for purchase matches the second item for purchase.

3. The method of claim 2, wherein the one or more additional images comprise one or more randomly selected images of items available for purchase.

4. The method of claim 1, wherein generating training data for the image recognition ML model based on the image and the determination that the first item for purchase matches the second item for purchase comprises including in the training data the image, identification of the first item for purchase, and an indication that the purchaser accurately identified the first item for purchase.

5. The method of claim 4, wherein the training of the ML model is based, at least in part, on the indication that the purchaser accurately identified the first item for purchase.

6. The method of claim 1, further comprising:
receiving a second image of a third item for purchase, wherein the second image is captured by a second POS system;
receiving a purchaser selection of a fourth item for purchase, wherein the purchaser makes the selection at the second POS system; and
determining that the third item for purchase does not match the second item for purchase, and in response:
generating training data for the image recognition ML model based on the image and the determination that the third item for purchase does not match the fourth item for purchase.

7. The method of claim 6, wherein determining that the third item for purchase does not match the second item for purchase comprises:
presenting the image of the third item for purchase, a third image relating to the fourth item for purchase, and one or more additional images on a user interface; and
receiving by the user interface an indication that the third item for purchase does not match the fourth item for purchase.

8. The method of claim 6, wherein generating training data for the image recognition ML model based on the image and the determination that the third item for purchase does not match the fourth item for purchase comprises:
including in the training data the image and an indication that the purchaser did not accurately identify the third item for purchase.

9. The method of claim 8, further comprising:
further training the ML model based, at least in part, on the indication that the purchaser did not accurately identify the third item for purchase.

10. A non-transitory computer-readable medium containing computer program code that, when executed by operation of a computer processor, performs an operation comprising:
receiving an image of a first item for purchase, wherein the image is captured by a point of sale (POS) system;
receiving a purchaser selection of a second item for purchase, wherein the purchaser makes the selection at the POS system; and
determining that the first item for purchase matches the second item for purchase, and in response:
generating training data for an image recognition machine learning (ML) model based on the image and the determination that the first item for purchase matches the second item for purchase; and
training the ML model using the training data, wherein the trained ML model is configured to recognize items for purchase in a plurality of images captured by a plurality of POS systems.

11. The non-transitory computer-readable medium of claim 10, wherein determining that the first item for purchase matches the second item for purchase comprises:
presenting the image of the first item for purchase, a second image relating to the second item for purchase, and one or more additional images on a user interface; and
receiving by the user interface an indication that the first item for purchase matches the second item for purchase.

12. The non-transitory computer-readable medium of claim 11, wherein the one or more additional images comprise one or more randomly selected images of items available for purchase.

13. The non-transitory computer-readable medium of claim 10, wherein generating training data for the image recognition ML model based on the image and the determination that the first item for purchase matches the second item for purchase comprises including in the training data the image, identification of the first item for purchase, and an indication that the purchaser accurately identified the first item for purchase.

14. The non-transitory computer-readable medium of claim 10, further comprising:
receiving a second image of a third item for purchase, wherein the second image is captured by a second POS system;
receiving a purchaser selection of a fourth item for purchase, wherein the purchaser makes the selection at the second POS system; and
determining that the third item for purchase does not match the second item for purchase, and in response:
generating training data for the image recognition ML model based on the image and the determination that the third item for purchase does not match the fourth item for purchase.

15. The non-transitory computer-readable medium of claim 14, wherein determining that the third item for purchase does not match the second item for purchase comprises:
presenting the image of the third item for purchase, a third image relating to the fourth item for purchase, and one or more additional images on a user interface; and
receiving by the user interface an indication that the third item for purchase does not match the fourth item for purchase.

16. A system, comprising:
a computer processor; and
a memory having instructions stored thereon which, when executed on the computer processor, performs an operation comprising:
receiving an image of a first item for purchase, wherein the image is captured by a point of sale (POS) system;
receiving a purchaser selection of a second item for purchase, wherein the purchaser makes the selection at the POS system; and
determining that the first item for purchase matches the second item for purchase, and in response:
generating training data for an image recognition machine learning (ML) model based on the image and the determination that the first item for purchase matches the second item for purchase; and
training the ML model using the training data, wherein the trained ML model is configured to recognize items for purchase in a plurality of images captured by a plurality of POS systems.

17. The system of claim 16, wherein determining that the first item for purchase matches the second item for purchase comprises:
presenting the image of the first item for purchase, a second image relating to the second item for purchase, and one or more additional images on a user interface; and
receiving by the user interface an indication that the first item for purchase matches the second item for purchase, and wherein the one or more additional images comprise one or more randomly selected images of items available for purchase.

18. The system of claim 16, wherein generating training data for the image recognition ML model based on the image and the determination that the first item for purchase matches the second item for purchase comprises including in the training data the image, identification of the first item for purchase, and an indication that the purchaser accurately identified the first item for purchase.

19. The system of claim 16, further comprising:
receiving a second image of a third item for purchase, wherein the second image is captured by a second POS system;
receiving a purchaser selection of a fourth item for purchase, wherein the purchaser makes the selection at the second POS system; and
determining that the third item for purchase does not match the second item for purchase, and in response:
generating training data for the image recognition ML model based on the image and the determination that the third item for purchase does not match the fourth item for purchase.

20. The system of claim 19, wherein determining that the third item for purchase does not match the second item for purchase comprises:
presenting the image of the third item for purchase, a third image relating to the fourth item for purchase, and one or more additional images on a user interface; and
receiving by the user interface an indication that the third item for purchase does not match the fourth item for purchase.
